(19) United States
(12) Patent Application Publication
(10) Pub. No.: US 2014/0377524 A1
(43) Pub. Date: Dec. 25, 2014

(54) INORGANIC FILLER, INSULATION LAYER INCLUDING THE SAME, AND SUBSTRATE USING INSULATION LAYER

(71) Applicant: Samsung Electro-Mechanics Co., Ltd., Suwon (KR)

(72) Inventors: Ye Jun PARK, Hwasung (KR); Byung Kun Kim, Seoul (KR); Jung Wook Seo, Hwasung (KR)

(73) Assignee: Samsung Electro-Mechanics Co., Ltd., Suwon (KR)

(21) Appl. No.: 14/049,716

(22) Filed: Oct. 9, 2013

(30) Foreign Application Priority Data
Jun. 25, 2013 (KR) 10-2013-0073014

(51) Int. Cl. C01B 33/12; C09C 1/28

(52) U.S. Cl. CPC C01B 33/12; C09C 1/28
USPC 428/220; 423/335; 428/402; 106/490

(57) ABSTRACT

An inorganic filler including a closed pore having a content of 1 to 30 vol. %, an insulation layer including the same, and a substrate using the insulation layer. With the insulation layer using the inorganic filler prepared so as to include a closed pore corresponding to a change rate in volume, the closed pore may offset change in volume in the inorganic filler and release stress, thereby improving a coefficient of thermal expansion according to change in temperature of the insulation layer.

### CROSS REFERENCE(S) TO RELATED APPLICATIONS

This application claims the benefit under 35 U.S.C. Section 119 of Korean Patent Application Serial No. 10-2013-0073014, entitled “Inorganic Filler, Insulation Layer Including the Same, and Substrate Using the Insulation Layer” filed on Jun. 25, 2013, which is hereby incorporated by reference in its entirety into this application.

### BACKGROUND OF THE INVENTION

1. Technical Field The present invention relates to an inorganic filler, an insulation layer including the same, and a substrate using the insulation layer.

2. Description of the Related Art

An insulation layer for a substrate material is capable of being fabricated by mixing a resin and a filler. The filler may be contained in order to improve physical properties such as insulation property, mechanical stiffness, coefficient of thermal expansion, and the like, and a compound such as SiO₂, or the like, may be generally used for the filler.

In particular, processes such as lamination, fabrication, and the like, are performed for forming a circuit on a multilayer substrate. The processes accompany change in temperature (300 or lower), and according to the temperature, the coefficient of thermal expansion of an insulation composite material is also changed, which causes defects including a change in a shape such as a dent, warpage, or the like, of the insulation layer.

Therefore, in order to improve yield at the time of manufacturing the substrate and manufacture a highly integrated/thinned substrate for new generation devices, coefficient of thermal expansion of the composite material and stress release during the process are an important matter.

An insulation layer is mainly made of the composite material of the filler and the resin, wherein each of the coefficients of thermal expansion of the filler material and the resin material has an influence on properties of the insulation layer. Since the coefficient of thermal expansion of an organic material resin is generally larger than that of an inorganic material filler, it is advantageous to increase a content (filling rate) of the filler.

In addition, as the content of the inorganic filler become increased, it becomes more important to decrease thermal expansion of the filler material itself.

The resin in the insulation layer, which is an organic material, has a coefficient of thermal expansion of about 50 ppm/K, and the inorganic filler such as SiO₂ has a coefficient of thermal expansion of about 0.5 ppm/K.

In order to stabilize thermal expansion of the insulation layer, the content of the inorganic filler having a relatively smaller expansion is increased, whereby an average value of the coefficient of thermal expansion of the composite material may be decreased.

In the case in which a spherical filler is filled at a high rate, at the time of random packing, the filler having the content close to about 60 vol. % may be generally implemented and at the time of close packing, the filler having the content of 78.5 vol. % may be ideally implemented. In addition, in the case in which a bimodal or trimodal filler prepared by mixing particles having uniform sizes of two kinds or three kinds together at an appropriate ratio is filled at a high rate, the filler having the content close to 92 or 99.9 vol. % may be secured, in theory.

One kind powder (Single-modal Close Packing)—inorganic filler content: 78.5 vol. %

Two kinds mixed powder (Bi-modal Close Packing)—inorganic filler content: 92.0 vol. %

Three kinds mixed powder (Bi-modal Close Packing)—inorganic filler content: 99.9 vol. %

In order to implement the content of the filler close to the ideal filling rate as described above, technology in dispersion and molding has been developed, and as technology for filling the filler is improved, the coefficient of thermal expansion of the filler itself has an increased influence on the entire insulation layer as the same as volume fraction.

Therefore, the coefficient of thermal expansion of the filler itself becomes more important, and the filler having an improved coefficient of thermal expansion is required to be developed.

### RELATED ART DOCUMENT

### Patent Document (Patent Document 1) Japanese Patent Laid-Open Publication No. 2011-016718

### SUMMARY OF THE INVENTION

An object of the present invention is to provide an inorganic filler included in an insulation layer to be capable of stabilizing thermal expansion property of an insulation layer.

In addition, another object of the present invention is to provide an insulation layer including the inorganic filler and a substrate using the same.

According to a first exemplary embodiment of the present invention, there is provided an inorganic filler including a closed pore having a content of 1 to 30 vol. %.

An average particle size of the inorganic filler may be 5 to 500nm.

The closed pore may have a size of 0.2 to 20% based on the average particle size of the inorganic filler.

The inorganic filler may be at least one selected from a group consisting of SiO₂, Al₂O₃, ZrO₂, ZnO, BaO, CaO, MgO, and SrO.

The inorganic filler may be surface-treated with a silane coupling agent.

According to a second exemplary embodiment of the present invention, there is provided an insulation layer including the inorganic filler as described above.

The inorganic filler may be included in the insulation layer by 30 to 70 vol. %.

According to a third exemplary embodiment of the present invention, there is provided a substrate including the insulation layer as described above.

The insulation layer may have a thickness of 20 μm or less.

### BRIEF DESCRIPTION OF THE DRAWINGS

FIG. 1 is a view showing a pore distribution in a particle of an inorganic filler including a closed pore according to an exemplary embodiment of the present invention;

FIG. 2 is a HR-TEM photograph of the inorganic filler including the closed pore prepared according to the exemplary embodiment of the present invention; and

FIG. 3 is a HR-TEM photograph of the inorganic filler not including the closed pore.

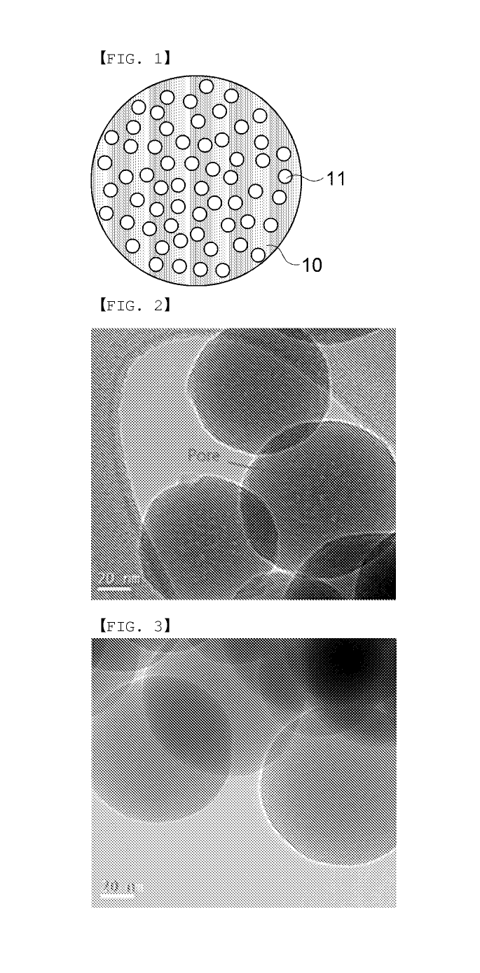

### DESCRIPTION OF THE PREFERRED EMBODIMENTS

Hereinafter, the present invention will be described in more detail.

Terms used in the present specification are for explaining the specific embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

The present invention relates to an inorganic filler included in a substrate insulation layer, an insulation layer including the same, and a substrate using the insulation layer.

The inorganic filler according to the exemplary embodiment of the present invention includes a closed pore therein, whereby the present invention has a technical property in that the inorganic filler allows change in volume according to change in temperature to be partially offset.

Therefore, it is preferred that the inorganic filler according to the exemplary embodiment of the present invention includes the closed pore having a content of 1 to 30 vol. %. The closed pore indicates only a closed pore included in the inorganic filler, and it is preferred that the pore is not included on a surface of the inorganic filler.

When it is defined that the pore is distributed in the filler, it is advantageous to control a moisture-absorption property of the filler and secure dispersibility of the filler, and in the case in which the pore is open and the open pore is present on the surface of the filler, a specific surface area of a particle is difficult to be controlled, such that it is disadvantageous in securing dispersibility and a filling rate, which is not preferred.

Therefore, the content of the closed pore included in the inorganic filler according to the exemplary embodiment of the present invention may have a value corresponding to a change rate in volume of the inorganic filler. That is, it means that the closed pore corresponding to the change rate in volume (within an error range which is the same as the change rate in volume or less than 10%) of each inorganic filler is included in the inorganic filler.

Therefore, in the case in which the content of the closed pore of the inorganic filler according to the exemplary embodiment of the present invention is less than 1 vol. %, effects such as volume offset and stress release are not efficient due to a reason that the core has irregular distribution, and in the case in which the content of the closed pore is more than 30 vol. %, the insulation layer has a problem in mechanical stiffness, which is not preferred.

It is preferred that the inorganic filler according to the exemplary embodiment of the present invention has an average particle size of 5˜500 nm, and the inorganic filler having the above-described average particle size is used alone or two or more kinds thereof are mixed together, and a particle size having a larger particle size in two or more kinds mixed filler is 1/10 or less than a thickness of the insulation layer.

In addition, the size of the closed pore included in the inorganic filler according to the exemplary embodiment of the present invention is 0.2 to 20% based on the average particle size of the inorganic filler, which is preferred in view of the matter that the change in volume is offset.

The inorganic filler may be at least one selected from a group consisting of SiO₂, Al₂O₃, ZrO₂, ZnO, BaO, CaO, MgO, and SrO, and any general inorganic filler used in the insulation layer may be used.

In addition, the inorganic filler according to the exemplary embodiment of the present invention may be surface-treated with a silane coupling agent if needed, and kinds of silane coupling agent are not particularly limited.

Further, the inorganic filler according to the exemplary embodiment of the present invention may have every shape such as a spherical shape having a symmetric structure, or a square shape, a plated shape, or the like, having an asymmetric structure, and a shape of the inorganic filler is not particularly limited.

The inorganic filler having the closed pore in a predetermined content according to the exemplary embodiment of the present invention may be prepared by known liquid-phase synthesis method such as a hydrothermal, a sol-gel, or the like. The liquid-phase synthesis method may be used to control the size and the content of the entire pore by control synthesis parameter and to classify a surface open pore and a surface closed pore through a heat treatment after synthesis thereof.

In addition, in the exemplary embodiment of the present invention, the insulation layer including the inorganic filler in which the closed pore has the content of 1 to 30 vol. % may be provided.

The pore having the predetermined content is included in the inorganic filler according to the exemplary embodiment of the present invention, thereby securing an empty space as the closed pore and when the inorganic filler accompanies the change in volume according to the change in temperature due to the empty space, the change in volume may be offset and the stress may be released. Therefore, the insulation layer such as an insulation layer, or the like, including the inorganic filler may have an improved change rate according to a temperature.

It is preferred that the inorganic filler according to the exemplary embodiment of the present invention is included by 30 to 70 vol. % in the entire insulation layer composition to control the coefficient of thermal expansion and secure mechanical stiffness.

The insulation layer according to the exemplary embodiment of the present invention may further include a base resin configuring the insulation layer, a solvent, and a dispersant in addition to the inorganic filler, and kinds of base resin, the solvent, and the dispersant, and the contents thereof are not particularly limited, but may be included to the extent that is used in the insulation layer of the general substrate.

In addition, in the exemplary embodiment of the present invention, the substrate including the insulation layer including the inorganic filler in which the closed pore has the content of 1 to 30 vol. % may be provided.

The insulation layer included in the substrate according to the exemplary embodiment of the present invention may be formed at a significantly thin thickness as compared to 20 μm or less of the insulation layer according to the related art.

In addition, in the substrate according to the exemplary embodiment of the present invention, the inorganic filler capable of decreasing thermal expansion is used in the insulation layer, whereby the entire coefficient of thermal expansion of the composite material (filler+resin) of the insulation layer may be decreased to improve warpage defect rate according to change in the insulation layer during a manufacturing process of the multilayer substrate.

Further, a process window of an insulation layer lamination which is expected that a frequency is increased and a process technology is secured according to the trend that the substrate is thinned and multilayered may be secured to be useful in developing the substrate in a new generation.

Hereinafter, a preferred example of the present invention will be described in detail. The example below is just exemplary described, but the scope of the present specification and claims should not be interpreted as being limited to the example. In addition, the example below is exemplified using specific compounds, but it is obvious to those skilled in the art that an effect obtained by using equivalents thereof can be the same as or similar to that of the present invention.

### Comparative Example

A non-porous inorganic filler (SiO₂) not including closed pores was used in order to compare an inorganic filler according to an exemplary embodiment of the present invention.

### Example

An insulation layer composition was prepared by using a silica inorganic filler (SiO₂) of 60 vol. % which includes the closed pore having the content as shown in the following Table 1, is surface-treated with a silane-coupling agent, and has an average particle size of 5 to 500 nm, an epoxy resin as a base resin, and a ketone-based/alcohol-based mixed solvent as a solvent, and mixing together.

The insulation layer composition was prepared to be an insulation sheet having a thickness of 15 μm. The stiffness of the insulation layer was measured by reflecting a dimension of the product based on shear modulus and whether or not warpage occurs in the substrate was confirmed as a defect rate during a process, and results thereof were shown in the following Table 1.

TABLE 1

| Sample | Content of Closed | Warpage | Stiffness of |
|---|---|---|---|
| No. | Pore (Vol. %) | Prevention ⁽¹⁾ | Insulation Layer ⁽²⁾ |
| 1* | 0 | X | ◯ |
| 2* | 0.01 | X | ◯ |
| 3* | 0.5 | X | ◯ |
| 4 | 1 | ◯ | ◯ |
| 5 | 2 | ◯ | ◯ |
| 6 | 5 | ◯ | ◯ |
| 7 | 10 | ◯ | ◯ |
| 8 | 20 | ◯ | ◯ |
| 9 | 25 | ◯ | ◯ |
| 10 | 30 | ◯ | ◯ |
| 11* | 35 | ◯ | X |
| 12* | 40 | ◯ | X |

*indicates an example out of the range of the present invention
⁽¹⁾ Warpage Prevention: X- Defective (less than 80%), ◯ - Good (80% or more)
⁽²⁾ Stiffness of Insulation Layer: X- Defective (less than 80%), ◯ - Good (80% or more)

It may be appreciated from Table 1 above that in the case in which the inorganic filler including the closed pore having the content of 1 to 30 vol. % was used for the insulation layer, an effect that the warpage of the substrate was prevented is excellent and the stiffness of the insulation layer was secured.

However, it was confirmed that in the case in which the closed pore has significantly low content less than 1 vol. %, the stiffness of the insulation layer was excellent but the warpage of the substrate was not sufficiently prevented and in the case in which the closed pore has significantly high content more than 30 vol. %, the warpage of the substrate was excellently prevented, but the stiffness of the insulation layer was deteriorated.

Therefore, it was confirmed that it is preferred that the inorganic filler including the closed pore having the appropriate content as described in the present invention is included in the insulation layer.

In addition, whether or not the closed pore is appropriately included in the inorganic filler according to the exemplary embodiment of the present invention was measured by using HR-TEM, and in the measurement of HR-TEM, the inorganic filler prepared by the example of the present invention and the inorganic filler prepared by the comparative example of the present invention were used. Results thereof were shown in FIGS. 2 and 3, respectively. In the HR-TEM, whether or not the closed pore is formed may be confirmed by a difference in contrast shown in the drawings of the present invention.

It was confirmed from HR-TEM photographs of FIGS. 2 and 3 that in the inorganic filler according to the exemplary embodiment of the present invention, a plurality of closed pores represented by white dots were formed in the inorganic filler, but the inorganic filler according to the related art had a non-porous structure without the closed pore like the present invention.

In addition, the average particle size of the inorganic filler according to the exemplary embodiment of the present invention measured based on the HR-TEM photograph was 93.98 nm, and the size of the pore in the inorganic filler was 1.71 nm (1.8% as compared to the filler). It was confirmed from the above-described results that in the inorganic filler prepared by the exemplary embodiment of the present invention, the closed pore had the content of 1 to 30 vol. %, and the closed pore has the size of 0.2 to 20% based on the average particle size of the inorganic filler.

With the insulation layer applying the inorganic filler prepared so as to include the closed pore corresponding to the change rate in volume thereto according to the exemplary embodiment of the present invention, the closed pore may offset the change in volume in the inorganic filler and release the stress, thereby improving the coefficient of thermal expansion according to the change in temperature of the insulation layer.

In addition, the content of the closed pore is appropriately adjusted, such that the moisture-absorption property of the inorganic filler may be controlled and the dispersibility of the filler may be advantageously secured.

Therefore, with the substrate using the insulation layer including the inorganic filler according to the exemplary embodiment of the present invention, the stability with respect to the change in temperature may be improved, and the stiffness may be secured.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. An inorganic filler comprising a closed pore having a content of 1 to 30 vol. %.

2. The inorganic filler according to claim 1, wherein an average particle size of the inorganic filler is 5 to 500 nm.

3. The inorganic filler according to claim 1, wherein the closed pore has a size of 0.2 to 20% based on the average particle size of the inorganic filler.

4. The inorganic filler according to claim 1, wherein the inorganic filler is at least one selected from a group consisting of SiO₂, Al₂O₃, ZrO₂, ZnO, BaO, CaO, MgO, and SrO.

5. The inorganic filler according to claim 1, wherein the inorganic filler is surface-treated with a silane coupling agent.

6. An insulation layer comprising the inorganic filler according to claim 1.

7. The insulation layer according to claim 6, wherein the inorganic filler is included in the insulation layer by 30 to 70 vol. %.

8. A substrate comprising the insulation layer according to claim 6.

9. The substrate according to claim 8, wherein the insulation layer has a thickness of 20 μm or less.
